(19) United States
(12) Patent Application Publication
(10) Pub. No.: US 2024/0375102 A1
(43) Pub. Date: Nov. 14, 2024

(54) MICROFLUIDIC DEVICE AND METHOD FOR PROCESSING BIOLOGICAL SAMPLES

(71) Applicant: Combinati Incorporated, Carlsbad, CA (US)

(72) Inventors: Ju-Sung Hung, Palo Alto, CA (US); Felicia Linn, Patterson, CA (US); Hien Nguyen, San Jose, CA (US)

(21) Appl. No.: 18/691,223

(22) PCT Filed: Sep. 14, 2022
(86) PCT No.: PCT/US2022/043544

§ 371 Date: Mar. 12, 2024

Related U.S. Application Data
(60) Provisional application No. 63/244,234, filed on Sep. 14, 2021.
(60) Provisional application No. 63/244,235, filed on Sep. 14, 2021.

(51) Int. Cl. B01L 3/00; B01L 7/00

(52) U.S. Cl. CPC B01L 3/502715; B01L 7/52; B01L 2200/16; B01L 2300/0654; B01L 2300/0861

(57) ABSTRACT

A microfluidic device for processing a sample comprises an inlet port fluidically coupled to a closed system is disclosed. The closed system comprises a plurality of linear loading conduits, a plurality of terminating chambers, and pluralities of microchambers for receiving the sample. Also disclosed are methods for drawing sample amounts into microchambers of the microfluidic device. One method includes a step of applying a plurality of pressure pulses to contents within the microfluidic assemblies, the plurality of pressure pulses comprising a first pressure applied for a first time interval and a second pressure applied for a second time interval, wherein a volume of the sample is drawn into a plurality of microchambers of the microfluidic device. These and other embodiments of microfluidic devices and methods are disclosed.

### CROSS-REFERENCE TO RELATED APPLICATIONS

This application claims the benefits of U.S. provisional application Nos. 63/244,234 and 63/244,235, both filed on Sep. 14, 2021. To the extent permitted in applicable jurisdictions, the entire contents of these applications are incorporated herein by reference.

### BACKGROUND

Microfluidic devices handle fluids on a small scale. Typically, a microfluidic device operates on a sub-millimeter scale and handles micro-liters, nano-liters, or smaller quantities of fluids.

One application of microfluidic structures is in digital polymerase chain reaction (dPCR). dPCR dilutes a nucleic acid sample down to one or less nucleic acid template in each chamber of a microfluidic structure providing an array of many chambers, and performs a PCR reaction across the array. By counting the chambers in which the template was successfully PCR amplified and applying Poisson statistics to the result, the target nucleic acid is quantified. Unlike the popular quantitative real-time PCR (qPCR), where templates are quantified by comparing the rate of PCR amplification of an unknown sample to the rate for a set of known qPCR standards, dPCR has proven to exhibit higher sensitivity, better precision and greater reproducibility.

For genomic researchers and clinicians, dPCR is particularly powerful in rare mutation detection, quantifying copy number variants, and Next Gen Sequencing library quantification. The potential use in clinical settings for liquid biopsy with cell free DNA and viral load quantification further increases the value of dPCR technology. Existing dPCR solutions have used elastomeric valve arrays, silicon through-hole approaches, and microfluidic encapsulation of droplets. Despite the growing number of available dPCR platforms, dPCR has been at a disadvantage when compared to the older qPCR technology which relies on counting the number of PCR amplification cycles. The combination of throughput, ease of use, performance and cost are the major barriers for gaining adoption in the market for dPCR.

### SUMMARY

In microfluidic devices, a major fouling mechanism is trapped air, or bubbles, inside the micro-structure. This can be particularly problematic when using a thermoplastic material to create the microfluidic structure, as the gas permeability of thermoplastics is very low. In order to avoid fouling by trapped air, previous microfluidic structures use either simple straight conduit or branched conduit designs with thermoplastic materials, or, alternative, the device is manufactured using high gas permeability materials such as elastomers. However, simple designs limit possible functionality of the microfluidic device, and elastomeric materials are both difficult and expensive to manufacture, particularly at scale.

Thus, cost-effective designs that may be used in manufacturing microfluidic devices that may be effectively used for dPCR are desired, such as microfluidic devices and structures using thermoplastic materials. In addition, as the gas permeability of thermoplastics is low, improved methods for reducing fouling in thermoplastic microfluidic devices by removing trapped air prior to performing the dPCR process on a sample are desired.

The present disclosure describes microfluidic devices for sample processing and/or analysis. A microfluidic device of the present disclosure may be formed from a polymeric material such as a thermoplastic material, and may include a gas-permeable film to allow for pressurized outgassing (degassing) while serving as a gas barrier when pressure is released. The use of thermoplastic to form the microfluidic device allows the use of an inexpensive and highly scalable injection molding process. The gas-permeable film may provide the ability to outgas via pressurization, avoiding the fouling problems that may be present in some microfluidic structures that do not include gas-permeable films.

Embodiments of the invention disclosed herein include a microfluidic device for processing a sample comprises an inlet port fluidically coupled to a closed system. The closed system comprises or consists essentially of, or consists of, a plurality of linear loading conduits, a plurality of terminating chambers, and pluralities of microchambers for receiving the sample. A terminating chamber of the plurality of terminating chambers is fluidically coupled to a linear loading conduit of the plurality of linear loading conduits. A plurality of microchambers of the pluralities of microchambers is fluidically coupled to a linear loading conduit of the plurality of linear loading conduits. With respect to a first plurality of microchambers and a first terminating chamber fluidically coupled to a same proximate linear loading conduit, a volume of the first terminating chamber is equal to or less than the combined volume of the first plurality of microchambers. No waste reservoirs larger than the terminating chambers are provided in the closed system. The inlet, loading conduits, microchambers and terminating chambers may all be in fluid communication with each other, and optionally are not in fluid communication with another conduit or chamber.

Some embodiments of the present invention disclose a microfluidic device for processing a sample, comprising: an inlet port; and a plurality of dead-ended microfluidic assemblies, each of which is fluidically coupled to the inlet port. Each of the dead-ended microfluidic assemblies comprises a linear loading conduit, a terminating chamber fluidically coupled to the linear loading conduit, and a plurality of microchambers for receiving the sample fluidically coupled and proximate to the linear loading conduit, wherein a volume of the terminating chamber is equal to or less than a combined volume of with plurality of microchambers. In some embodiments, at least one (e.g., all) microchambers are dead-ended. A dead-ended microchamber optionally does not allow sample fluid or other liquid exchange other than a loading conduit, for example via a siphon conduit that fluidly connects the microchamber to the loading conduit.

Embodiments of the present invention disclosed herein also include a microfluidic device for processing a sample comprising an inlet port fluidically coupled to an array of loading conduits and sample-receiving microchambers via a first microconduit portion, and a wide-conduit portion fluidically coupled between the inlet port and the first microconduit portion. The first microconduit portion has a depth less than a depth of the wide conduit portion. The first microconduit portion comprises a straight-line path. The wide-conduit portion comprises a path including at least one of a non-straight line path or a straight-line path oriented differently that the straight-line path of the first microconduit portion.

Another embodiment of the present invention disclosed herein includes a microfluidic device for processing a biological sample, comprising: an inlet port; and a plurality of loading conduits, each fluidically coupled to the inlet port and to a plurality of microchambers. The embodiment includes plurality of siphon conduits, where each siphon conduit fluidically couples a loading conduit to a microchamber. The microchamber comprises a first side substantially facing a loading conduit and a second side that in some embodiments is not substantially facing a loading conduit, e.g., is not parallel to a loading conduit. In some embodiments, the second side is not facing an adjacent microchamber; and a siphon conduit fluidically couples the loading conduit to the microchamber via the second side. In some embodiments, the siphon conduit has a non-linear, (e.g., a curved) shape in order to connect the loading conduit to the second side of a microchamber. Optionally, the orifice of the siphon conduit in the loading conduit is situated upstream of the portion of the loading conduit that is in closest proximity to the microchamber.

Some embodiments of the present invention discussed herein disclose a microfluidic device for processing a biological sample, comprising: an inlet port, and a plurality of loading conduits. Each loading conduit is fluidically coupled to the inlet port and to a plurality of microchambers, wherein a microchamber of the plurality of microchambers comprises a substantially rectangular three-dimensional shape comprising four substantially rectangular side walls. Two adjacent sidewalls are joined by a curved corner.

Methods of processing a biological sample in a microfluidic device comprising a plurality of microfluidic assemblies are disclosed. Each microfluidic assembly is configured to process the sample using a digital PCR process. Each of the microfluidic assemblies comprises an inlet, a loading conduit fluidically coupled at a first end to the inlet, one or more dead-ended microchambers configured to receive the sample, and a siphon conduit fluidically coupled to the microchamber and the loading conduit. The method includes a step of applying a plurality of pressure pulses to contents within the microfluidic assemblies. In an embodiment, applying a plurality of pressure pulses comprises alternating between applying a first pressure for a first time interval and applying a second pressure for a second time interval, wherein a volume of the sample is drawn into a plurality of microchambers of the microfluidic device.

Methods of loading a biological sample into a microfluidic device for processing the biological sample are also disclosed. In some embodiments, the microfluidic device comprises an inlet, one or more loading conduits fluidically coupled at a first end to the inlet, a plurality of microchambers for receiving and/or digitizing the biological sample, and a plurality of siphon conduits fluidically coupling the plurality of microchambers with the one or more loading conduits. The microfluidic device further comprises a gas-permeable film that forms a surface of one or more loading conduits, microchambers, and siphon conduits.

In these method embodiments, a plurality of pressure pulses is applied to fluid contents of the microfluidic device. The plurality of pressure pulses comprises a plurality of peaks having a first pressure applied for a first time interval alternating with a plurality of valleys comprising a second pressure applied for a second time interval. After the series of pressure pulses is applied, gas bubbles present within the plurality of microchambers is forced to pass through the gas permeable film, and a volume of reagent comprising the biological sample is drawn into the microchambers of the microfluidic device.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

FIG. 1 illustrates a microfluidic device in accordance with an embodiment of the present invention;

FIG. 2 illustrates a microfluidic device processing unit in accordance with an embodiment of the present invention;

FIG. 3 illustrates a bottom perspective view of a portion of a microfluidic device processing unit in accordance with an embodiment of the present invention;

FIG. 4 illustrates a bottom view of a portion of a microfluidic device processing unit in accordance with an embodiment of the present invention;

FIG. 5 illustrates a side elevation view of a portion of a microfluidic device processing unit as shown in FIG. 4 along the axis labeled “A-B”;

FIG. 6A illustrates a bottom view of a portion of a microfluidic device processing unit in accordance with an embodiment of the present invention;

FIG. 6B illustrates a side elevation view along the axis labeled “A-B” of the portion of the microfluidic device processing unit as shown in FIG. 6A;

FIG. 7 illustrates a method of manufacture of embodiments of the present invention;

FIG. 8 illustrates a block diagram of an exemplary machine usable with one or more embodiments of the invention to perform a digital PCR process for a biological sample;

FIG. 9 illustrates a schematic representation of a device for sample processing and/or analysis, along with a pneumatic unit for use in providing microfluidic device fluid loading control;

FIG. 10 illustrates an exemplary sample digitization process of one or more embodiments of the present invention;

FIG. 11 illustrates a graph depicting a pressure pulsing process of one or more embodiments of the present invention;

FIG. 12 illustrates an exemplary digital PCR laboratory workflow that may be performed by the machine illustrated in FIG. 8 in accordance with one or more embodiments of the invention described herein; and

FIG. 13 illustrates a digital PCR process used in accordance with one or more embodiments of the present invention.

While the invention is described with reference to the above drawings, the drawings are intended to be illustrative, and other embodiments are consistent with the spirit, and within the scope, of the invention.

### DETAILED DESCRIPTION

Embodiments of the present invention describe a microfluidic device that provides microfluidic structures formed out of thermoplastic injection molding process, incorporating a semi-permeable thin film that is selectively permeable to air but not to the sample liquid to allow for pressurized outgassing while serving as a gas barrier when pressure is released. The use of thermoplastic to form the microfluidic structures allows the use of an inexpensive and highly scalable injection molding process, while the thin film provides the ability to outgas via pressurization, avoiding the fouling problems in some microfluidic structures that do not contain thin films. The microfluidic device structure design incorporates an array of dead-ended microchambers connected by linear loading conduits (microconduits) and siphon conduits and formed out of thermoplastics. Embodiments of the present invention incorporate functional designs optimized for manufacturability that can be used in a digital PCR application to deposit samples into an array of microchambers, and thereby be used to quantify nucleic acids in digital PCR (dPCR).

The various embodiments now will be described more fully hereinafter with reference to the accompanying drawings, which form a part hereof, and which show, by way of illustration, specific examples of practicing the embodiments. This specification may, however, be embodied in many different forms and should not be construed as limited to the embodiments set forth herein; rather, these embodiments are provided so that this specification will be thorough and complete, and will fully convey the scope of the invention to those skilled in the art. Among other things, this specification may be embodied as methods or devices. Accordingly, any of the various embodiments herein may take the form of an entirely hardware embodiment, an entirely software embodiment or an embodiment combining software and hardware aspects. The following specification is, therefore, not to be taken in a limiting sense.

All publications, patents, and patent applications mentioned in this specification are herein incorporated by reference to the same extent as if each individual publication, patent, or patent application was specifically and individually indicated to be incorporated by reference.

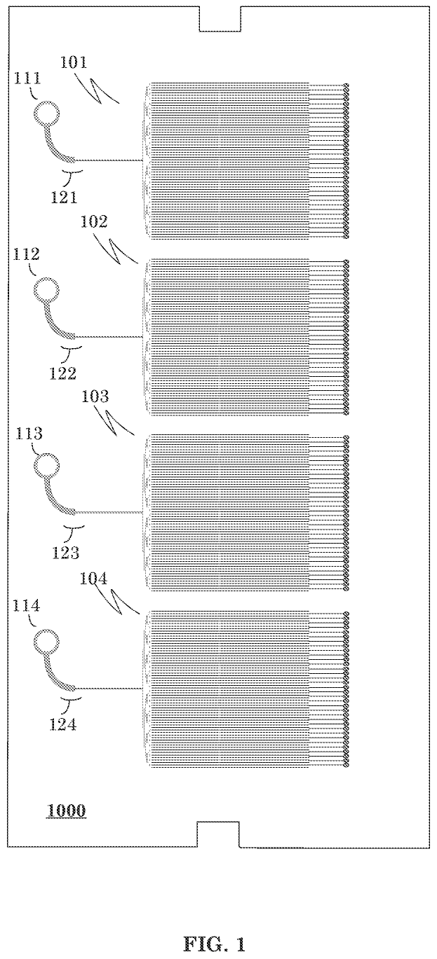

FIG. 1 illustrates a microfluidic device slide 1000 in accordance with an embodiment of the present invention for processing a sample. A plurality of slides may be bonded to an automation compatible plate frame by welding. The plate frame may be a standard format plate frame with single inlet wells as is known in the art. Other suitable methods may also be employed to bond the plurality of slides together. In one embodiment of the invention, single slide 1000 as shown in FIG. 1 is a 4-unit array, and comprises a plurality of processing units. For example, slide 1000 in FIG. 1 includes four processing units 101, 102, 103 and 104. In other embodiments, the slide 1000 may contain less than or more than four processing units; for example, slide 1000 may contain 1, 2, 3, 4, 5, 6, 7, 8, 9 or 10 processing units. Processing units (“devices”) 101-104 shown in FIG. 1 includes respective inlet ports: Inlet port 111 for device 101, port 112 for device 102, port 113 for device 103, and port 104 for device 104. The devices 101 104 may include a single inlet port or multiple inlet ports in various embodiments of the invention. Other embodiments may include one, two, or more inlet ports.

Methods used in embodiments of the present invention may include applying a single or multiple pressure differentials to the inlet port to direct the solution from the inlet port to a conduit, e.g., a loading conduit 121-124 as shown in FIG. 1 for devices 101-104 respectively. Alternatively, or in addition to, the device may include multiple inlet ports and the pressure differential may be applied to the multiple inlet ports. The inlet of the device (e.g., a microfluidic device) may be fluidically coupled to or in fluid communication with a fluid control module, such as a pneumatic pump, vacuum source, or compressor. The fluid control module may provide positive or negative pressure to the inlet. The fluid control module may apply a pressure differential to fill the device with a sample and deposit (e.g., digitize) the sample into the chamber or microchamber. Alternatively, or in addition to, the sample may be deposited into a plurality of chambers or microchambers as described elsewhere herein. In one or more embodiments of the invention, filling and depositing of the sample may be performed without the use of valves between the chambers or microchambers to load the sample within the chamber of microchambers. For example, filling of the conduit may be performed by applying one or more pressure differentials between the sample in the inlet port and the conduit. The pressure differential(s) may be achieved by pressurizing the sample or by applying vacuum to the conduit and/or the chambers or microchambers continuously for one or more specified time durations. Filling the chambers and depositing the solution comprising the sample may be performed by applying a pressure differential for a specified duration of time between the conduit and the chambers. This may be achieved by pressurizing the conduit via the inlet port(s) or by applying a vacuum to the chambers. The solution comprising the sample may enter the chambers such that each chamber contains a portion of the sample.

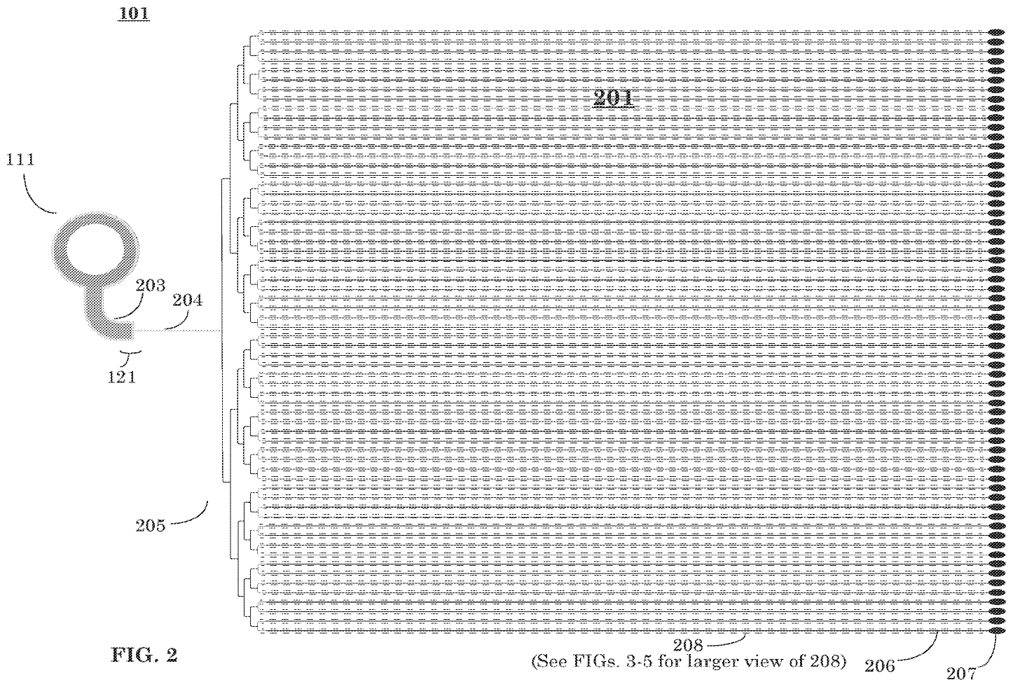

FIG. 2 includes an illustration of exemplary microfluidic device processing unit 101 from FIG. 1, in accordance with an embodiment of the present invention. In this embodiment, microfluidic device processing unit 101 comprises a closed system 201 fluidically coupled to inlet port 111. Aside from inlet port 111, there is no other inlet wherein fluids may enter the closed system 201, and there are no outlets or outlet ports wherein liquids may exit the closed system 201. Inlet port 111 is fluidically coupled to closed system 201 via loading conduit 121 comprising wide conduit portion 203, which is coupled at a first end to input port 111 and a second end to a step-down conduit portion (e.g., first microconduit portion) 204. Step-down conduit portion 204 is fluidically coupled at one end to wide conduit portion 203 and at the other end to loading conduit network portion 205. Loading conduit network portion 205 is fluidically coupled to step-down conduit portion 204, wide conduit portion 203, and inlet port 111 with closed system 201. In one embodiment of the invention, the loading conduit network portion 205 incorporates a “splitter” design, wherein from the step-down conduit portion 204, it splits into 2, 4, 8, 16, 32, and then 64 conduits with equal fluidic resistance (having a conduit depth and width similar to step-down conduit portion 204) to distribute the reagent evenly. In one embodiment of the invention, the splitter design may utilize curved paths or turns having radii of curvature similar to those discussed below.

Closed system 201 comprises a plurality of linear loading conduits 206 and is connected to loading conduit network portion 205 via a fluidic connection or coupling to each separate linear loading conduit 206. Each linear loading conduit 206 is fluidically coupled to a terminating chamber 207 at one end and a plurality microchambers 208. In one embodiment of the invention, terminating chamber 207 may comprise a receptacle or reservoir for waste or potential “overfill” such as excess fluid, reagent, or sample that may, if not properly routed into terminating chamber 207, cause the reagent to cross talk during the dPCR process. Aside from the plurality of terminating chambers 207 and the plurality of microchambers 208, in some embodiments of the invention closed system 201 includes no other reservoirs for waste and/or fluid receptacles. Thus, each linear loading conduit, along with its proximate microchambers and terminating chamber, may also comprise a microchamber assembly and may be dead-ended.

In some embodiments, the number of microchambers 208 in closed system 201 is between 10,000 and 30,000. In one embodiment of the invention, a plurality of microchambers 208 fluidically coupled to a same proximate loading conduit are arranged in two rows, one row of microchambers positioned on each side of a linear loading conduit 206. Each linear loading conduit 206 is also fluidically coupled to input port 207. Other potential arrangements of microchambers within a microconduit may also be used within embodiments of the present invention. For example, arrangements, systems, methods, devices and systems disclosed in U.S. Pat. No. 9,845,499 to Hung et al., which is herein incorporated by reference in its entirety, U.S. Patent Publication No. 2019/0264260 to Zayac et al., which is also herein incorporated by reference in its entirety, and U.S. Patent Publication No. 2020/0384471 to Lin et al., which is also herein incorporated by reference in its entirety, may all be used within embodiments of the present invention.

In some embodiments of the invention, the volume of terminating chamber is larger than the volume of the microchamber 208. In one embodiment of the invention, the volume of the terminating chamber is at least about 4 times the volume of the microchamber. In one embodiment of the invention, the volume of the terminating chamber is less than or equal to 10% of the total combined volume of the plurality of microchambers that are fluidically coupled to the same proximate linear loading conduit 206. In other embodiments of the invention, the volume of the terminating chamber is at least about 5, 10, 15, 20 or more times the volume of the microchamber. In some embodiments of the invention, the volume of a terminating chamber is less than or equal to about 0.0001%, 0.001%, 0.01%, 0.1%, 1%, 10%, 20%, 25%, 30%, 35%, 40%, 45%, 50%, 100%, 200% or more of the total combined volume of the plurality of microchambers that are fluidically coupled to the linear loading conduit 206. In some embodiments of the invention, the combined volume of all terminating chambers is less than or equal to about 0.0001%, 0.001%, 0.01%, 0.1%, 1%, 10%, 20%, 25%, 30%, 35%, 40%, 45%, 50%, 100%, 200% or more of the total combined volume of the plurality of microchambers that are fluidically coupled to the linear loading conduit 206. In other embodiments, the inlet port 111 is fluidically coupled to a sample reservoir, and the volume of a terminating chamber is less than or equal to about 0.0001%, 0.001%, 0.01%, 0.1%, 1%, 10%, 20%, 25%, 30%, 35%, 40%, 45%, 50%, 100%, 200% or more of the total combined volume of the plurality of microchambers that are fluidically coupled to the linear loading conduit 206.

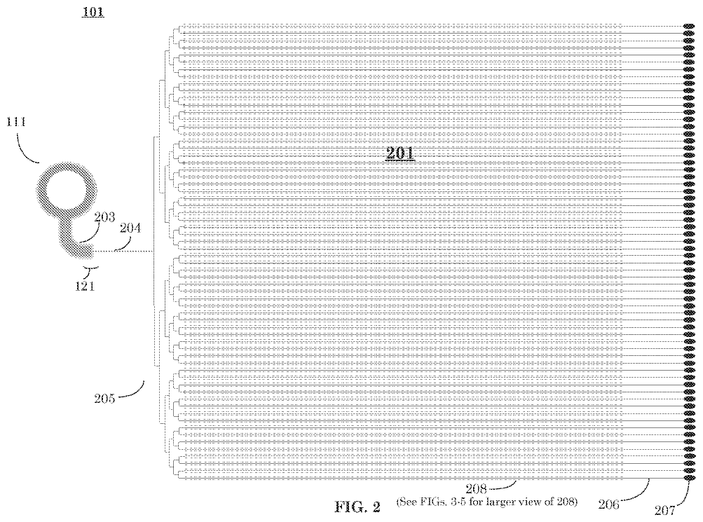

FIG. 3 illustrates a bottom perspective view of a portion of the microfluidic device processing unit in accordance with an embodiment of the present invention, showing a portion of two linear loading conduits 206. In one embodiment of the invention, linear loading conduit 206 has a depth of about 10 microns. In one embodiment of the invention, linear loading conduit 206 is fluidically coupled to a plurality of microchambers 208. Each microchamber 208 is fluidically coupled to linear loading conduit 206 via a siphon conduit 302. In some embodiments of the invention, siphon conduit 302 has a depth of at least about 10 microns, and microchamber 208 has a depth of at least about 100 microns.

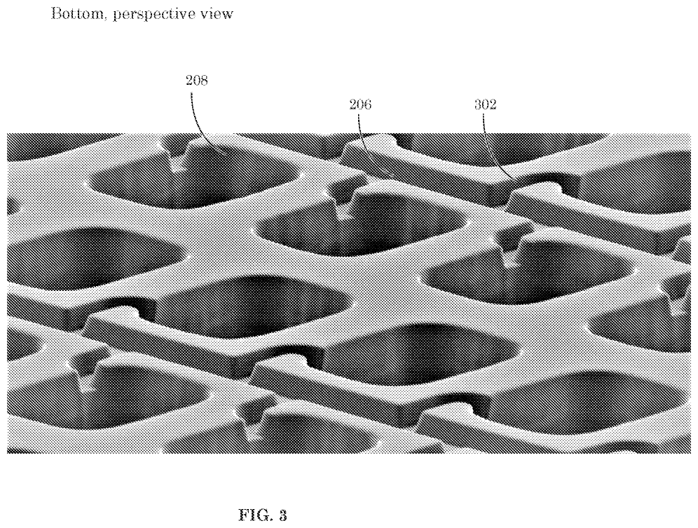

FIG. 4 illustrates a bottom view of a portion of the microfluidic device processing unit in accordance with an embodiment of the present invention showing a portion of linear loading conduit 206 with four microchambers 208, positioned in two rows of two microchambers along the linear loading conduit portion 208. Microchamber 208 is connected to linear loading conduit 206 by siphon conduit 302. In some embodiments of the invention, microchamber 208 is a substantially rectangular three-dimensional shape as shown in FIGS. 3 and 4.

In one embodiment of the invention, the microchamber comprises four substantially rectangular side walls, four side edges, four top (or bottom) edges, and a substantially rectangular top (or bottom) wall or base, wherein each side wall is connected to two other side walls by a side edge and the top (or bottom) wall is connected to each side wall by the four top (or bottom) edges. In some embodiments of the invention, each edge of the four side edges comprises a circular arc of at least about 90 degrees. In one embodiment of the invention, the circular arc comprises a radius of at least about 10 microns. In the injection molding process, having 90-degree sharp edges or corners may be physically prohibitive. Adding radius of curvature to the 90-degree corners of a rectangular microchamber helps with mold release of the injection molds. Prior art microfluidic devices known in the art commonly utilized cylindrically shaped microchambers, which are easier to manufacture using an inexpensive and highly scalable injection molding process. However, as it is highly desirable in dPCR applications to increase sensitivity of the dPCR results by increasing the total analyzed volume, microchambers having a rectangular shape are preferred over cylindrically shaped microchambers as the rectangular microchamber has a larger volume over a cylindrical shape having similar dimensions. In one embodiment of the invention, rectangular microchambers 208 having a radius of curvature for each side edge of at least about 10 microns significantly improves manufacturability of the microfluidic device using injection molded processes, while still increasing the total analyzed volume per microchamber over prior art microfluidic structures.

While it is on the one hand optimal for the dPCR process to maximize the use of space by fitting as many microchambers as possible on a microfluidic device, current thermoplastic injection molding limitations make it challenging to create a tall and thin plastic wall, so for manufacturability purposes, some spacing between microchambers may be needed to ensure structural integrity. Manufacturability may also be aided by positioning microchambers equidistant from each other in a row adjacent to a linear loading conduit. Aspect ratio, as used in some embodiments of the present invention, may be defined as the height of the microchamber divided by the distance between two microchambers in a row or between rows. FIGS. 3 and 4 also show microfluidic structures in some embodiments of the present invention having an aspect ratio of at least about 3. Thus, in one embodiment of the invention, if the depth (or height) of a microchamber is 105 microns, a minimum distance between two microchamber is at least about three. In another embodiment of the invention, the ratio of a depth of the microchamber to a minimum distance between two microchambers is at least about five. Aspect ratios of at least about 3, 5 or higher may be utilized in other embodiments of the present invention.

In some embodiments of the invention, siphon conduit 302 as shown in FIGS. 3 and 4 comprises a portion of the path to the microchamber. To avoid cross talk of dPCR reagents, for example, it is desirable to maximize the distance of the path between microchambers. In addition, reducing siphon conduit presence between microchambers and adding radii of curvature to the perimeter of both the base and the opening of microchambers helps with ejection of the injection molded structures as well, as sharp corners are more difficult to demold. Thus, a siphon conduit that comprises a non-straight line path may be included in embodiments of the present invention. In some embodiments of the present invention, the non-straight line path comprises at least one of: a circular arc of at least about 90 degrees, a 90-degree angle, an acute angle, an obtuse angle, a curve, a plurality of curves, or a plurality of angles. In one embodiment of the invention, the non-straight line path comprises a circular arc substantially equal to about 90 degrees and having a radius of at least about 10 microns.

In addition, from a manufacturability perspective, adding siphon conduits and placement of siphon conduits in between microchambers may increase mold filling difficulties (similar to how injection molding process limitations may make it more challenging to create a tall and thin wall). Therefore, longer siphoning conduits of substantially equal length, and substantially equally spaced between microchambers, may be considered optimal from a perspective of avoidance of cross-talk of PCR reagents. In one embodiment of the invention, the plurality of siphon conduits may be positioned at locations that are substantially equidistant from adjacent siphon conduits on the linear loading conduit.

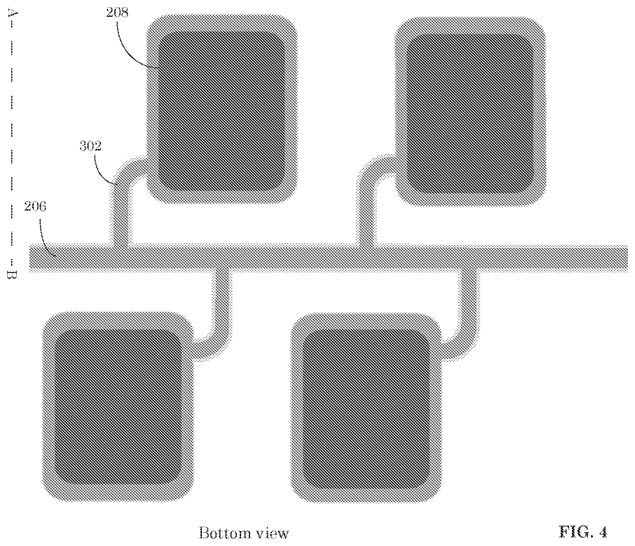

FIG. 5 illustrates a side elevation view of a portion of the microfluidic device processing unit as shown in FIG. 4 along the axis labeled “A-B”. Thermoplastic microfluidic structures including microchamber 208 is shown with the base wall facing the “Top”, and siphon conduit 302 positioned near the “Bottom” and fluidically coupled to microchamber 208 and linear loading conduit 206. Thin film 501 covers all microfluidic structures from the “Bottom” as labeled on FIG. 5. The labeling of “Top” and “Bottom” on FIG. 5 reflects its positioning on a standard format plate frame, where the plate containing the processing units including the microfluidic structures is flipped upside down and then laser welded to a frame with reservoirs. In one embodiment of the invention, the thickness of the microfluidic structures of FIG. 5 from Top to Bottom (without the film) is approximately 1.5 mm. Thin film 501 is used to cover a surface the microfluidic structures. The thin film is gas impermeable at lower pressures, but allows for out-gassing through the thin film when pressure is applied, and is thus at least partially gas permeable under pressure. In some embodiments of the invention, the gas-permeable film is not gas permeable at atmospheric pressure, but is gas-permeable at a pressure that is higher than atmospheric pressure. In some embodiments, the thin film is gas-permeable but not liquid-permeable at one or more selected pressures above atmospheric pressure. In some embodiments of the present invention, the thin film is approximately 80 microns in thickness and composed of a cyclic olefin polymer. One suitable thin film used in embodiments of the present invention is a semi-gas permeable film TOPAS® COC 6013. In other embodiments of the invention, semi-gas permeable films having a thickness of 60, 70, 80, 90, 100 microns or any range within those thicknesses may be used.

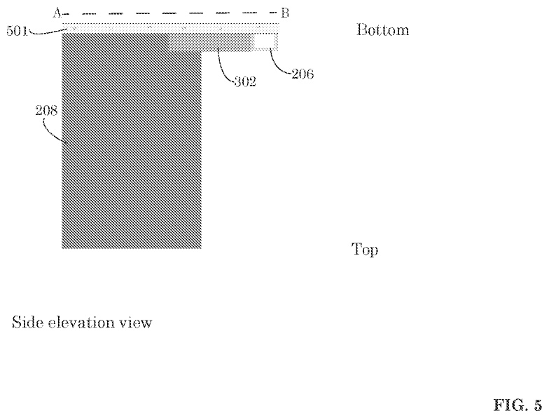

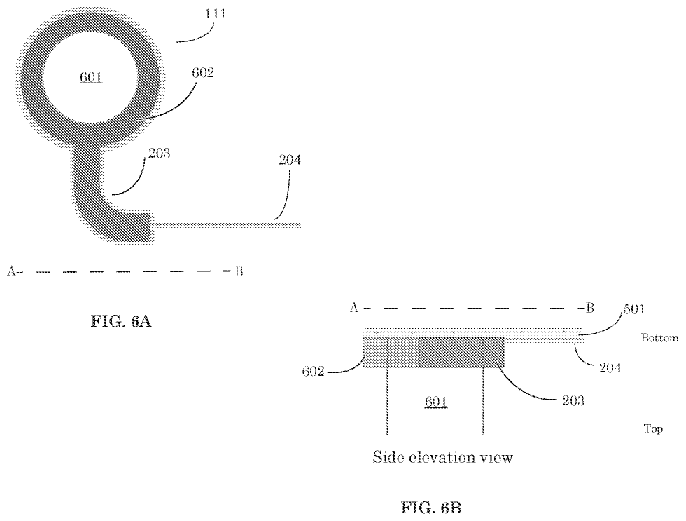

FIG. 6A illustrates a top view of a portion of a microfluidic device processing unit depicting inlet port 111. Inlet port 111 comprises inlet 601 and landing pad 602. FIG. 6A also shows wide conduit portion 203 fluidically coupled to inlet port 111, and step-down conduit portion 204 fluidically coupled to wide conduit portion 203. FIG. 6B illustrates a side elevation view of a portion of the microfluidic device processing unit depicting the inlet port 111, wide conduit portion 204, and step-down conduit portion 204 as shown in FIG. 6A along the axis labeled “A-B”. Thin film 501 is used to cover a surface of the structures depicted in FIGS. 6A and 6B.

Various features shown in FIGS. 6A and 6B are included in embodiments of the invention to improve manufacturability during the thermoplastic injection molding process. For injection molding, one creates a molding tool to receive melted plastics. An insert, which may generally be made from nickel, has the inverse microfluidic features, including the microchambers, microconduits and the landing pad, which will be “inserted” into the molding tool. The “insert pins” are part of the molding tool, which is on the opposite side of the insert. When the mold closes, the insert pins hit the landing pads, the melted plastics move into the mold, transcribing the microfluidic features on the insert. When the mold cools down, the plastics form the microfluidic devices, and get ejected from the mold.

In some embodiments of the invention, inlet port 111 comprises angled side walls that may be formed using a mask during the thermoplastic injection molding process to prevent formation of undercuts after repeated pin impact for inlet 601, which theoretically increases insert life, and also to enable smoother part ejection by reducing sticking. In addition, in some embodiments of the present invention, landing pad 602 includes a wider diameter than inlet 601, thereby better accommodating pin impacts without damaging the edge of the landing pad. The landing pad 602 is a feature used during the microfluidic injection molding process and refers to the circular area to receive “insert pins”, which forms the through holes in the plastic device. The insert pin will physically “hit” the landing pad in every shot, deteriorating the pad. Landing pad 602 may also include angled side walls at a draft angle. Without a draft angle, it may be difficult to eject the thermoplastic piece from the mold. Landing pads having a draft angle will assist with easier mold release. Thicker landing pads, and landing pads having a larger “pad” or diameter may improve insert life span and also give more tolerance to insert pin location variations. A draft angle (tilt from the straight vertical line) may, in the embodiments of the invention discussed herein, exist at approximately 5 degrees, but may be anywhere from a range of at least about 2 degrees to at least about 5 degrees and higher. Anything below 2 degrees may present challenges to release.

Wide conduit portion 203 is shown in FIG. 6A as having a curve or turn of about 90 degrees before directing path into narrower step-down conduit portion 204, which has a depth of approximately 10 microns, similar to the microconduits splitter network and the plurality of linear loading conduits. In one embodiment of the invention, the 90 degree turn in the wide conduit portion comprises a 90-degree circular arc having a radii of curvature of at least about 10 microns, 25 microns, 50 microns, 100 microns, or greater. In other embodiments of the invention, turns of other angles may be used in wide conduit portion 204, e.g., acute angles, obtuse angles, curves, and/or multiple curves and angles. In embodiments of the invention disclosed herein, including the 90 degree turn in a wider conduit before stepping down prevents constriction of the narrower loading conduits at areas of sharp turns, as the result of natural part shrinkage when the plastic cools down after the injection molding process. Such constriction at the turn may cause the narrower conduit to get stuck during ejection and therefore deforming. During the injection molding process, it may be that if there is a 90 degree turn in a microconduit having a 10-micron depth and/or width, the conduit may be reduced to a 6-to-8-micron dimension in either direction, thereby causing a potential conduit blockage issue.

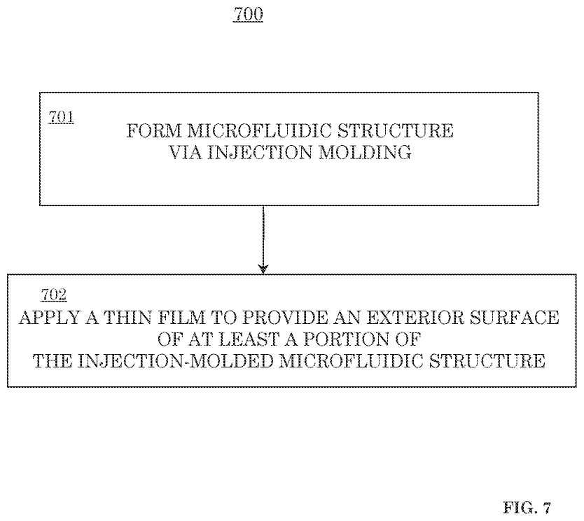

FIG. 7 illustrates a method of manufacture used in embodiments of the present invention. In FIG. 7, an injection molding process 701 is used to form a microfluidic structure or device. The microfluidic device includes an array of microchambers, which are connected to at least one loading conduit and/or microconduit via siphon conduits or siphon apertures, as shown in FIGS. 3 and 4. A surface of the microfluidic structure is covered by a semi-gas-permeable film. In the covering process, an opening in at least one surface of the microfluidic structure is covered over in order to fully enclose the microstructures including the inlet port, loading conduits, microconduits, siphon conduits, microchambers, and terminating chambers. In some embodiments of the present invention, the covering is performed by a process 702 of applying a thin film to the injection molded microfluidic structure.

In an aspect, the present disclosure provides an apparatus for using a microfluidic device to analyze nucleic acid samples. The apparatus may comprise a transfer stage configured to hold one or more microfluidic devices. The microfluidic devices may comprise a microconduit with an inlet and an outlet, a plurality of microchambers connected to the microconduit by a plurality of siphon apertures, and a thin film forming a surface of the microfluidic device. The apparatus may comprise a pneumatic module in fluid communication with the microfluidic device. The pneumatic module may load reagent into the microfluidic device and deposit the reagent into the microchambers. The apparatus may comprise a thermal module in thermal communication with the plurality of microchambers. The thermal module may control the temperature of the microchambers and thermal cycle the microchambers. The apparatus may comprise an optical module capable of imaging the plurality of microchambers. The apparatus may also comprise a computer processor coupled to the transfer stage, pneumatic module, thermal module, and optical module. The computer processor may be programmed to (i) direct the pneumatic module to load reagent into the microfluidic device and deposit the reagent into the plurality of microchambers, (ii) direct the thermal module to thermal cycle the plurality of microchambers, and (iii) direct the optical module to image the plurality of microchambers.

The transfer stage may be configured to input the microfluidic device, hold the microfluidic device, and output the microfluidic device. The transfer stage may be stationary in one or more coordinates. Alternatively, or in addition to, the transfer stage may be capable of moving in the X-direction, Y-direction, Z-direction, or any combination thereof. The transfer stage may be capable of holding a single microfluidic device. Alternatively, or in addition to, the transfer stage may be capable of holding at least 2, at least 3, at least 4, at least 5, at least 6, at least 7, at least 8, at least 9, at least 10, or more microfluidic devices.

The pneumatic module may be configured to be in fluid communication with the inlets and the outlets of the microfluidic device. The pneumatic module may have multiple connection points capable of connecting to multiple inlets and multiple outlets. The pneumatic module may be able to fill and/or backfill a single array of microchambers at a time or multiple arrays of microchambers in tandem. The pneumatic module may further comprise a vacuum module. The pneumatic module may provide increased pressure to the microfluidic device or provide vacuum to the microfluidic device.

The thermal module may be configured to be in thermal communication with the microchambers of the microfluidic devices. The thermal module may be configured to control the temperature of a single array of microchambers or to control the temperature of multiple arrays of microchambers. The thermal control module may perform the same thermal program across all arrays of microchambers or may perform different thermal programs with different arrays of microchambers.

The optical module may be configured to emit and detect multiple wavelengths of light. Emission wavelengths may correspond to the excitation wavelengths of the indicator and amplification probes used. The emitted light may include wavelengths with a maximum intensity around about 450 nm, 500 nm, 525 nm, 550 nm, 575 nm, 600 nm, 625 nm, 650 nm, 675 nm, 700 nm, or any combination thereof. Detected light may include wavelengths with a maximum intensity around about 500 nm, 525 nm, 550 nm, 575 nm, 600 nm, 625 nm, 650 nm, 675 nm, 700 nm, or any combination thereof. The optical module may be configured to emit one, two, three, four, or more wavelengths of light. The optical module may be configured to detect one, two, three, four, or more wavelengths of light. On emitted wavelength of light may correspond to the excitation wavelength of indicator molecule. Another emitted wavelength of light may correspond to the excitation wavelength of the amplification probe. One detected wavelength of light may correspond to the emission wavelength of an indicator molecule. Another detected wavelength of light may correspond to an amplification probe used to detect a reaction within the microchambers. The optical module may be configured to image sections of an array of microchambers. Alternatively, or in addition to, the optical module may image an entire array of microchambers in a single image.

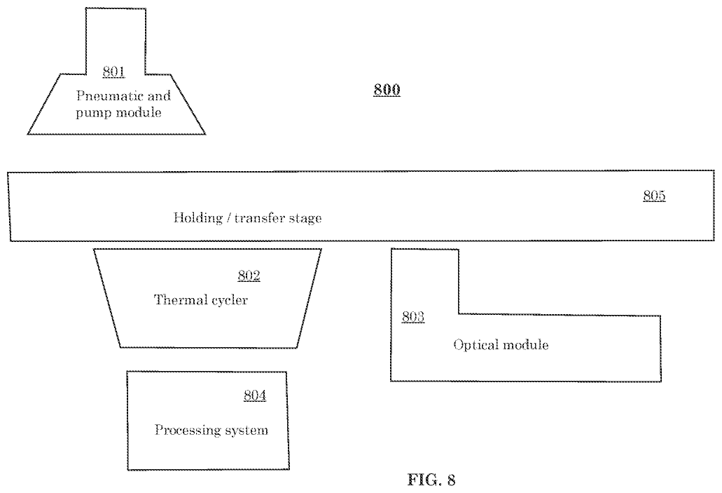

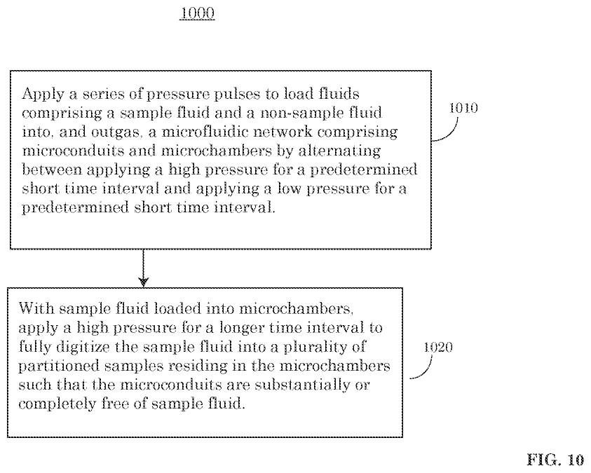

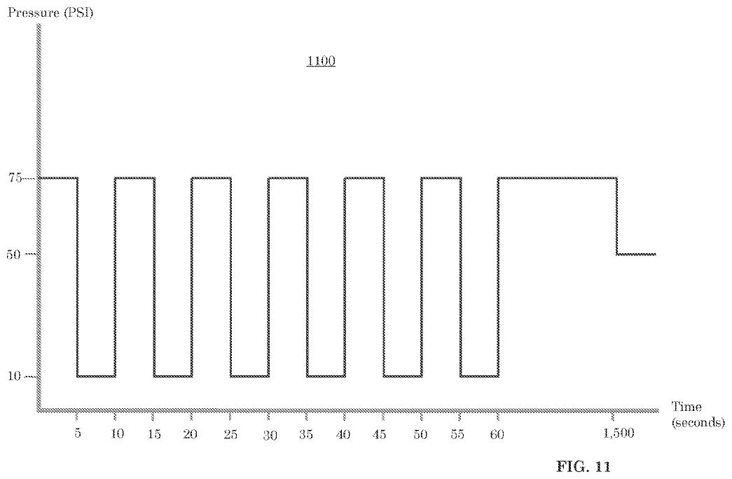

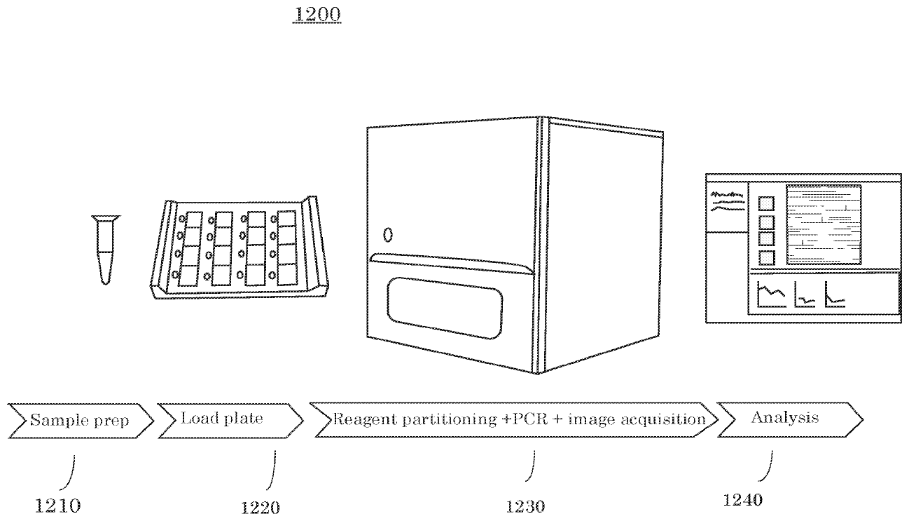

FIG. 8 illustrates a machine 800 for performing a digital PCR process as discussed below in FIG. 12. The machine 800 includes a pneumatic and pump module 801, which contains pumps and manifolds and may be moved in a Z-direction, operable to perform the application of pressure as described in FIG. 10 and FIG. 11. The application of pressure to the air refers to the air that is already in the microfluidic device at atmospheric pressure and then getting compressed as the pressure is applied to push in the fluid (e.g., sample fluid overlaid with non-sample fluid). Machine 800 also includes a thermal module 802, such as a flat block thermal cycler, to thermally cycle the microfluidic device and thereby cause the polymerase chain reaction to run. Machine 800 further includes an optical module 803, such as an epi-fluorescent optical module, which can optically determine which microchambers in the microfluidic device have successfully run the PCR reaction. The optical module 803 may feed this information to a processing system 804, which uses Poisson statistics to convert the raw count of successful microchambers into a nucleic acid concentration. A transfer stage 805 may be used to move a given microfluidic device between the various modules and to handle multiple microfluidic devices simultaneously. The microfluidic device described above, combined with the incorporation of this functionality into a single machine, reduces the cost, workflow complexity, and space requirements for dPCR over other implementations of dPCR.

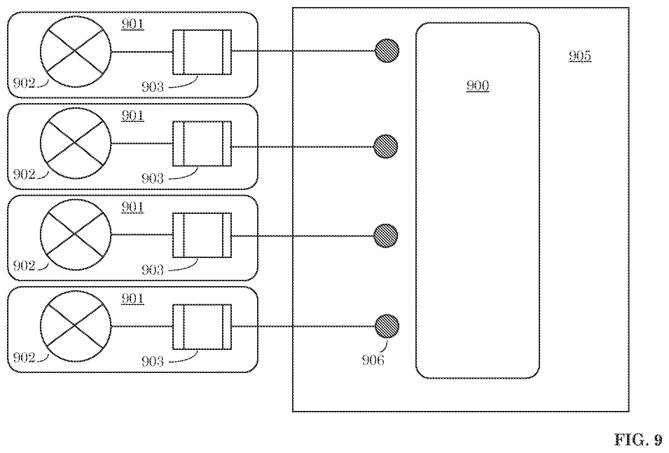

FIG. 9 illustrates a schematic representation of a slide 900 on a frame 905 along with pneumatic units 901 for use in providing device fluidic control for fluids introduced to four different sample processing units (previously illustrated and described but not separately shown in FIG. 9) on slide 900. Fluids held in reservoirs 906 are introduced to the sample processing units through inlets of the processing units (inlets not separately shown in FIG. 9). As described herein a sequence pressure pulses comprising low and high pressures applied to the reservoirs 906 loads sample solution/reagent into the microchambers (not separately shown) within the processing unit. Pneumatic units 901 controls the application of these pressures, and each unit 901 includes an electronic pressure regulator 902 and at least one valve 903. Units 901 interface with frame 905 via an appropriate mechanism such as, for example, an O-ring, to transmit pressure to reservoirs 906. More or fewer valves may be incorporated (e.g., depending on number of reservoirs and/or whether separate pressure control for each reservoir is desired). The frame 905 and/or slide 900 may include mechanical keys to aid in orientation and registration, such as a tab, or other visual feature (such as a registration mark, not shown).

FIG. 10 illustrates an exemplary sample digitization process 1010 of one or more embodiments of the present invention described herein. In step 1010 of FIG. 10, fluids or solutions comprising a sample may be loaded into the inlet port of a microfluidic device or processing unit. The microfluidic device may comprise an inlet port, loading conduit, and a plurality of chambers or microchambers as discussed above. The fluids loaded into the microfluidic device in step 1010 may comprise a fluid or solution containing a sample, or may include a fluid or solution that does not contain a sample, or may include both a sample fluid and a non-sample fluid.

High pressure may be applied to compress the air in the microfluidic network including the loading conduits, linear loading conduits, siphon conduits, microchambers, and terminating chambers, which draws sample fluid into the microfluidic network. The amount of fluid being drawn in should roughly equal to the air being compressed according to the ideal gas law. Since the volume of the loading conduits (having at least about 10 microns depth and at least about 10 microns width) is smaller than the volume of the microchambers (having at least about 100 microns depth), all the loading conduits should be filled with the sample fluid upon this action, meaning most of the compressed air will stay in the microchambers and the terminating chambers. Compressed air will continue to escape through the thin film, drawing more sample fluid into the network of microconduits, loading conduits, siphon conduits and into the microchambers. Non-sample fluid overlaid on top of the sample fluid will later be drawn into the microfluidic network while the sample fluid continues to replace the space occupied by the air, which continues to escape through the film.

In step 1010, a series of one or more pressure pulses may be applied to the inlet port of a microfluidic device. The pressure pulse may comprise applying a high pressure for a first predetermined time period, e.g., a short time interval, followed immediately by applying a low pressure for a second predetermined time period, e.g., a short time interval. In one embodiment of the invention, the pulsing starts at the beginning (where there is no fluid in the array since the material is hydrophobic) for 1 minute (6 cycles of 75 Psi/10 Psi for 5 seconds/5 seconds). In other words, a higher-pressure pulse may be applied at 75 psi for a short time interval, e.g., 5 seconds, followed immediately by a lower pressure pulse at 10 psi for a short time interval, e.g., 5 seconds, followed immediately again by the higher-pressure pulse at 75 psi for 5 seconds. The higher-pressure pulse followed by the lower pressure pulse may thus repeatedly be applied for successive 5 second time intervals for 6 cycles. In other embodiments of the invention, a higher or lower number of cycles may be contemplated, e.g., 5, 10, 12, 20, or more cycles. Different higher-pressure pulses or lower-pressure pulses may also be applied, e.g., less than or greater than 10 psi for the lower-pressure pulse, or greater than or less than 75 psi for the higher-pressure pulses.

In step 1020, after the series of pressure pulses has been applied, solution or fluid including the sample may be loaded into one or more of the plurality of microchambers. A high pressure, e.g., 75 psi, may be applied for a predetermined time period, e.g., a longer time interval, e.g., 24 minutes in one embodiment of the invention, to fully digitize the sample fluid into a plurality of microchambers, wherein sample fluid resides in the plurality of microchambers. The reason for step 1020 is that some small amount of air, e.g., air bubbles, may still be trapped inside the microchambers. Thus, applying the continuous pressure for 24 minutes at 75 Psi allows the microfluidic device to continue to outgas—most likely through both dissolution of air into the sample, and slow outgassing if the air is no longer in contact with the surface of the film. Finally, in some embodiments of the invention, a lower equilibration pressure, e.g., 50 psi, may be applied prior to the start of the dPCR process for a predetermined time period, e.g., 5 minutes, before the start of the dPCR process. In one embodiment of the invention, the reason to reduce to 50 psi for 5 minutes is because the pressure is held at 50 psi during dPCR. If the closed system is not equilibrated before PCR starts, where the temperature is heated to 96 degrees Celsius, any residual air in the closed system may expand, push sample out, and cause crosstalk.

To reduce crosstalk between the deposited samples, the conduits or microconduits fluidically coupled to the microchambers may be substantially or completely free of sample fluid following step 1020. To accomplish this, in one embodiment the volume of sample fluid injected into the inlet port of the microfluidic device is less or substantially less than a total volume of the chambers or microchambers of the microfluidic device. For example, in one embodiment, the total volume of all microchambers in a processing unit is around 11 microliters, whereas only 9 microliters of sample fluid may be loaded into the processing unit. In other embodiments, the total volume of sample fluid is less than a total combined volume of the microchambers of the microfluidic device, e.g., the volume of sample fluid loaded in the microfluidic device is less than about 90%, 80%, 70%, 60%, 50%, 40%, 30%, 20% of the total combined volume. In some embodiments, a non-sample fluid different from the sample fluid may have also been loaded into the inlet port as noted in step 1010 discussed above. Following step 1020, non-sample fluid may thus reside primarily in the conduits and/or microconduits and at the bottom of the microchambers (held in place by surface tension), where the sample fluid primarily resides in the chambers and microchambers. In one embodiment of the present invention, sample fluid in one chamber may substantially not be in fluid communication with sample fluid located in another chamber following step 1020.

FIG. 11 illustrates a graph 1100 depicting a pressure pulsing process of one or more embodiments of the present invention as discussed above, where pressure (PSI) is plotted on the y-axis and time (seconds) is plotted on the x-axis.

In some cases, alternate processes or methods to the process described in relation to FIG. 10 and FIG. 11 above may be employed for digitizing a sample. For example, one single pressure differential may be used to deliver the sample solution (e.g., containing nucleic acid molecules of interest) to the conduit, and the same pressure differential may be used to continue to digitize (e.g., delivering the solution from the conduit to the chamber) the chamber with the solution. Moreover, the single pressure differential may be sufficiently high to permit pressurized off-gassing or degassing of the conduit and/or chamber. Alternatively, or in addition to, the pressure differential to deliver the solution comprising the sample to the conduit may be a first pressure differential. The pressure differential to deliver the solution from the conduit to the chamber(s) may be a second pressure differential. The first and second pressure differentials may be the same (e.g., equal) or they may be different. In an example, the second pressure differential is greater than the first pressure differential. Alternatively, the second pressure differential may be less than the first pressure differential. The first pressure differential, the second pressure differential, or both may be sufficiently high to permit pressurized off-gassing or degassing of the conduit and/or chamber. In some cases, a third pressure differential may be used to permit pressurized off-gassing or degassing of the conduit and/or chamber. Pressurized off-gassing or degassing of the conduit or chamber(s) may be permitted by a film or membrane. For example, when a pressure threshold is reached the film or membrane may permit gas to travel from the chamber and/or conduit through the film or membrane to an environment outside of the chamber and/or conduit.

FIG. 12 illustrates an exemplary digital PCR process that may be performed by the machine illustrated in the FIG. 8 using one or more embodiments of the invention described herein. The digitization processes an easily be integrated into common laboratory workflow for nucleic acid assays as illustrated in FIG. 12. Biological sample preparation in step 1210 (sample prep step) may be performed as in other PCR-based workflows known in the art that include nucleic acid isolation and combining of master mix and primers/probes with the biological sample. A master mix is a mixture containing precursors and enzymes used as an ingredient in RT-PCR techniques in molecular biology. Such mixtures as known in the art may contain at least a mixture dNTPs, MgCl₂, Taq polymerase, a pH buffer and come mixed in nuclease-free water. The microfluidic device plate shown in step 1220 (load plate step) is loaded as described herein with respect to FIGS. 10 and 11 (e.g., pipetting of sample fluid mixture followed by pipetting of an oil overlay) followed by being placed into an instrument similar to that shown in FIG. 8 as described herein that integrates pneumatic loading and digitization of the reagents, thermocycling, and data/image acquisition (sample digitizing+PCR+image acquisition step). The acquired data of the PCR reaction can then be analyzed by software downstream to provide results such as concentration of target genes in the biological sample.

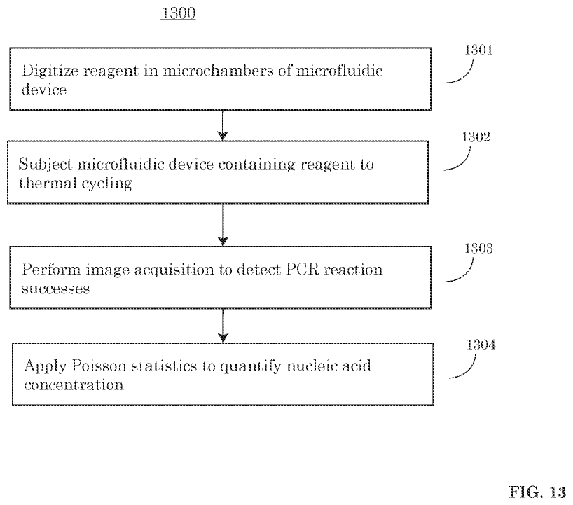

FIG. 13 illustrates a digital PCR process used in accordance with one or more embodiments of the present invention described above. In step 1301, the reagent (fluid) containing the sample is digitized in the microchambers of the microfluidic device. In step 1302, the reagent is subjected to thermal cycling to run the PCR reaction on the digitized reagent in the microchambers. This step may be performed, for example, using a flat block thermal cycler as described above with respect to FIG. 8. In step 1303, image acquisition is performed to determine which microchambers have successfully run the PCR reaction. Image acquisition may, for example, be performed using a three-color probe detection unit. In step 1304, Poisson statistics are applied to the count of microchambers determined in step 1303 to convert the raw number of positive chambers into a quantifiable nucleic acid concentration.

### Terminology

Terminology used herein with reference to embodiments of the present invention disclosed in this document should be accorded its ordinary meaning according to those of ordinary skill in the art unless otherwise indicated expressly or by context.

“Chamber” refers to a structure that enables depositing in a microfluidic device of a non-sample fluid, a fluid containing a sample, such as a biological sample, or a solution or reagent that includes a sample. Examples of structures that enable sample depositing and digitization include wells, chambers, and microchambers.

“Conduit” refers to a structure that enables a path of movement of a sample fluid or a non-sample fluid. Examples of structures that enable paths of fluid movement include conduits, passages, microconduits, micropassages, siphon conduits, siphon passages, and siphon apertures.

“Depth” as used with reference to microfluidic devices discussed in this specification generally refers to the distance measured from the bottom of a conduit, siphon aperture or conduit, chamber, or microchamber to the top of a side wall of the conduit, siphon aperture or conduit, chamber, or microchamber, or to the gas-permeable film or thin film that covers the conduit, siphon aperture or conduit, chamber, or microchamber.

“Digitized” or “digitization” may be used interchangeably and generally refers to a sample that has been distributed into one or more microchambers. A digitized sample may or may not be in fluid communication with another digitized sample. A digitized sample may not exchange materials (e.g., reagents, analytes) or interact with another digitized sample. Examples of structures that enable sample digitization include wells, chambers, and microchambers.

“Fluid” generally refers to a liquid or a gas. A fluid does not maintain a defined shape and will flow, or move such that particles of the fluid undergo a continual change in area during an observable time frame to fill a container into which it is placed. Thus, the fluid may have any suitable viscosity that permits movement. If two or more fluids are present, each fluid may be independently selected among essentially any fluid (liquids, gases, or the like) by those of ordinary skill in the art.

“Microfluidic” generally refers to a device, structure, article, area, system, or chip including at least one conduit, and optionally a plurality of siphon apertures or conduits, and an array of chambers or microchambers. For example, a conduit may have a cross-sectional dimension of less than or equal to about 1 millimeter, less than or equal to about 750 microns, less than or equal to about 500 microns, less than or equal to about 250 microns, less than or equal to about 100 microns, or less. A conduit or siphon conduit or aperture may have a cross-sectional dimension of less than or equal to about 50 microns, less than or equal to about 10 microns, or less.

“Pressurized off-gassing” or “pressurized degassing” may be used interchangeably and generally refers to removal or evacuation of one or more gasses (e.g., air, nitrogen, oxygen, carbon dioxide, etc.) from a conduit, aperture, or chamber of a device such as a microfluidic device to an environment external from the chamber, conduit, or aperture through the application of a pressure differential. The pressure differential may be applied between the conduit or chamber and the environment external to the conduit or chamber. The pressure differential may be provided by the application or a pressure source to one or more inlets to the device or the application of a vacuum source to one or more surfaces of the device. Pressurized off-gassing or pressurized degassing may be permitted through a gas-permeable film, thin film, or membrane covering one or more sides of the conduit, chamber, or aperture.

“Sample,” as used herein generally refers to any sample containing or suspected of containing a nucleic acid molecule. For example, a sample can be a biological sample including one or more nucleic acid molecules. The biological sample can be obtained (e.g., extracted or isolated) from or include blood (e.g., whole blood), plasma, serum, urine, saliva, mucosal excretions, sputum, stool and tears. The biological sample can be a fluid or a tissue sample (e.g., skin). Samples may be obtained from a cell-free bodily fluid, and may include cell-free DNA or cell-free RNA. Samples may include tumor cells. In some embodiments, samples may comprise environmental samples (e.g., soil, waste, water, ambient air, etc.), industrial samples (e.g., samples from any industrial processes), or food samples (e.g., dairy products, vegetable products, and meat products). The sample may be processed prior to loading into the microfluidic device. For example, the sample may be processed to lyse cells, purify the nucleic acid molecules, and/or include reagents.

### Additional Embodiments

Embodiment 1A. A microfluidic device configured to process a sample, comprising: an inlet port; and a closed system fluidically coupled to the inlet port, wherein the closed system comprises: a plurality of linear loading conduits; a plurality of terminating chambers, a terminating chamber of the plurality of terminating chambers fluidically coupled to a linear loading conduit of the plurality of linear loading conduits; and pluralities of microchambers for receiving the sample, a plurality of microchambers of the pluralities of microchambers fluidically coupled to a linear loading conduit of the plurality of linear loading conduits; wherein, with respect to a first plurality of microchambers and a first terminating chamber fluidically coupled to a same proximate linear loading conduit, a volume of the first terminating chamber is equal to or less than the combined volume of the first plurality of microchambers and further wherein waste reservoirs larger than any one of the terminating chambers are excluded from the closed system.

Embodiment 2A. The microfluidic device of embodiment 1A further comprising a plurality of siphon conduits, a siphon conduit of the plurality of siphon conduits fluidically coupled between a linear loading conduit and a microchamber.

Embodiment 3A. The microfluidic device of embodiment 1A, wherein a volume of the terminating chamber is larger than a volume of a microchamber of the plurality of microchambers.

Embodiment 4A. The microfluidic device of embodiment 3A, wherein the volume of the terminating chamber is at least about 4 times the volume of the microchamber.

Embodiment 5A. The microfluidic device of embodiment 2A, wherein a first dimension of the linear loading conduit and of the siphon conduit is less than about 10 microns.

Embodiment 6A. The microfluidic device of embodiment 1A, wherein a microchamber of the plurality of microchambers has a first dimension of at least about 100 microns.

Embodiment 7A. The microfluidic device of embodiment 1A, further comprising: a thin film applied to the microfluidic device wherein the thin film forms a surface of the closed system.

Embodiment 8A. The microfluidic device of embodiment 7A wherein the surface formed by the thin film provides an outer surface of the pluralities of microchambers.

Embodiment 9A. The microfluidic device of embodiment 8A wherein the surface formed by the thin film provides an outer surface of the plurality of linear loading conduits.

Embodiment 10A. The microfluidic device of embodiment 9A wherein the surface formed by the thin film provides an outer surface of the plurality of terminating chambers.

Embodiment 11A. The microfluidic device of any of embodiments 7A-10A, wherein the thin film has a thickness between about 70 and 90 microns.

Embodiment 12A. The microfluidic device of any of embodiments 7A-10A wherein the thin film has a thickness of about 80 microns.

Embodiment 13A. The microfluidic device of any of embodiments 7A-12A, wherein the thin film comprises a gas-permeable thermoplastic material.

Embodiment 14A. The microfluidic device of embodiment 13A wherein the gas-permeable thermoplastic material is not permeable to the sample.

Embodiment 15A. The microfluidic device of any of embodiments 13A-14A, wherein the gas-permeable thermoplastic material comprises a cyclic olefin copolymer.

Embodiment 16A. The microfluidic device of any of embodiments 1A-15A wherein the volume of the first terminating chamber is equal to or less than fifty percent (50%) of the combined volume of the first plurality of microchambers.

Embodiment 17A. The microfluidic device of any of embodiments 1A-15A wherein the volume of the first terminating chamber is equal to or less than twenty-five percent (25%) of the combined volume of the first plurality of microchambers.

Embodiment 18A. The microfluidic device of any of embodiments 1A-15A wherein the volume of the first terminating chamber is equal to or less than ten percent (10%) of the combined volume of the first plurality of microchambers.

Embodiment 19A. The microfluidic device of any of embodiments 1A-18A comprising: an injection-molded thermoplastic material.

Embodiment 1B. A microfluidic device configured to process a sample, comprising: an inlet port; and a plurality of dead-ended microfluidic assemblies, each of which is fluidically coupled to the inlet port, wherein each of the dead-ended microfluidic assemblies comprises: a linear loading conduit, a terminating chamber fluidically coupled to the linear loading conduit, and a plurality of microchambers configured for receiving the sample fluidically coupled and proximate to the linear loading conduit, wherein a volume of the terminating chamber is equal to or less than a combined volume of the plurality of microchambers.

Embodiment 2B. The microfluidic device of embodiment 1B wherein, each of the dead-ended microfluidic assemblies further comprises a plurality of siphon conduits, and a siphon conduit of the plurality of siphon conduits is fluidically coupled between the linear loading conduit and a microchamber of the plurality of microchambers.

Embodiment 3B. The microfluidic device of embodiment 1B, wherein the volume of the terminating chamber is larger than a volume of a microchamber of the plurality of microchambers.

Embodiment 4B. The microfluidic device of embodiment 3B, wherein the volume of the terminating chamber is at least about 4 times the volume of the microchamber.

Embodiment 5B. The microfluidic device of embodiment 2B, wherein a first dimension of the linear loading conduit and a first dimension of the siphon conduit are each less than about 10 microns.

Embodiment 6B. The microfluidic device of embodiment 1B, wherein a microchamber of the plurality of microchambers has a first dimension of at least about 100 microns.

Embodiment 7B. The microfluidic device of embodiment 1B, further comprising a thin film applied to the microfluidic device wherein the thin film forms a surface of the microfluidic device.

Embodiment 8B. The microfluidic device of embodiment 7B wherein the surface formed by the thin film provides an outer surface of the plurality of microchambers.

Embodiment 9B. The microfluidic device of embodiment 8B wherein the surface formed by the thin film further provides an outer surface of the linear loading conduit.

Embodiment 10B. The microfluidic device of embodiment 9B wherein the surface formed by the thin film further provides an outer surface of the terminating chamber.

Embodiment 11B. The microfluidic device of any of embodiments 7B-10B, wherein the thin film has a thickness between about 70 and 90 microns.

Embodiment 12B. The microfluidic device of embodiment any of embodiments 7B-10B wherein the thin film has a thickness of about 80 microns.

Embodiment 13B. The microfluidic device of any of embodiment 7B-12B, wherein the thin film comprises a gas-permeable thermoplastic material.

Embodiment 14B. The microfluidic device of embodiment 13B wherein the gas-permeable thermoplastic material is not permeable to the sample.

Embodiment 15B. The microfluidic device of any of embodiments 13B-14B, wherein the gas-permeable thermoplastic material comprises a cyclic olefin copolymer.

Embodiment 16B. The microfluidic device of any of embodiments 1B-15B wherein the volume of the terminating chamber is equal to or less than fifty percent (50%) of the combined volume of the plurality of microchambers.

Embodiment 17B. The microfluidic device of any of embodiments 1B-15B wherein the volume of the terminating chamber is equal to or less than twenty-five percent (25%) of the combined volume of the plurality of microchambers.

Embodiment 18B. The microfluidic device of any of embodiments 1B-15B wherein the volume of the terminating chamber is equal to or less than ten percent (10%) of the combined volume of the plurality of microchambers.

Embodiment 19B. The microfluidic device of any of embodiments 1B-18B further comprising an injection-molded thermoplastic material.

Embodiment 1C. A microfluidic device configured to process a sample, comprising: an inlet port fluidically coupled to an array of loading conduits and sample-receiving microchambers via a first microconduit portion; and a wide-conduit portion fluidically coupled between the inlet port and the first microconduit portion, the first microconduit portion having a depth less than a depth of the wide conduit portion; wherein the first microconduit portion comprises a straight-line conduit and the wide-conduit portion comprises a portion including at least one of a non-straight line conduit or a straight-line conduit oriented differently that the straight-line conduit of the first microconduit portion.

Embodiment 2C. The microfluidic device of embodiment 1C, wherein the depth of the wide-conduit portion is at least about 100 microns.

Embodiment 3C. The microfluidic device of embodiment 2C, wherein the depth of the first microconduit portion is about 10 microns or less.

Embodiment 4C. The microfluidic device of embodiment 1C, wherein the path of the first microconduit path comprises at least one of: a curve of at least about 90 degrees, a 90-degree angle, an acute angle, an obtuse angle, a curve, a plurality of curves, or a plurality of angles.

Embodiment 5C. The microfluidic device of embodiment 1C, wherein the microfluidic device is a thermoplastic injection molded microfluidic device.

Embodiment 6C. The microfluidic device of embodiment 1C, further comprising a thin film in the form of a surface of the microfluidic device.

Embodiment 7C. The microfluidic device of embodiment 6C wherein the thin film provides an outer surface of the sample-receiving microchambers.

Embodiment 8C. The microfluidic device of embodiment 7C wherein the thin film in the form of the surface further provides an outer surface of the loading conduits.

Embodiment 9C. The microfluidic device of any of embodiments 6C-8C, wherein the thin film has a thickness between about 70 and 90 microns.

Embodiment 10C. The microfluidic device of embodiment any of embodiments 6C-8C wherein the thin film has a thickness of about 80 microns.

Embodiment 11C. The microfluidic device of any of embodiments 6C-10C, wherein the thin film comprises a gas-permeable thermoplastic material.

Embodiment 12C. The microfluidic device of embodiment 13C wherein the gas-permeable thermoplastic material is not permeable to the sample.

Embodiment 13C. The microfluidic device of any of embodiments 6C-12C, wherein the gas-permeable thermoplastic material comprises a cyclic olefin copolymer.

Embodiment 14C. The microfluidic device of any of embodiments 1C-13C wherein at least a portion of said microfluidic device is substantially optically transparent.

Embodiment 15C. The microfluidic device of any of embodiments 1C-14C, wherein the microfluidic device is one of a plurality of microfluidic devices that collectively form a continuous injection-molded thermoplastic part.

Embodiment 16C. The microfluidic device of embodiment 15C, wherein the microfluidic device is not fluidically coupled to another microfluidic device of the plurality of microfluidic devices.

Embodiment 1D. A microfluidic device configured to process a biological sample, comprising: an inlet port; a plurality of microchambers; a plurality of loading conduits, each fluidically coupled to the inlet port and to the plurality of microchambers; and a plurality of siphon conduits, each of the siphon conduits fluidically coupling a loading conduit to a microchamber wherein: a microchamber of the plurality of microchambers comprises a first side, optionally substantially facing a loading conduit and a second side that is not facing a loading conduit, or is substantially facing an adjacent microchamber of the plurality of microchambers; and a siphon conduit fluidically couples the loading conduit to the microchamber via the second side.

Embodiment 2D. The microfluidic device of embodiment 1D wherein the siphon conduit comprises a curved conduit.

Embodiment 3D. The microfluidic device of embodiment 2D wherein the curved path comprises a turn of about 90 degrees.

Embodiment 4D. The microfluidic device of embodiment 2D wherein the curved conduit comprises a turn having a radius of curvature of at least about 10 microns.

Embodiment 5D. The microfluidic device of embodiment 1D, wherein each of the plurality of siphon conduits is substantially equal in length.

Embodiment 6D. The microfluidic device of embodiment 1D, wherein each of the plurality of siphon conduits are located at substantially equidistant positions on the loading conduit.

Embodiment 7D. The microfluidic device of embodiment 1D, wherein the microfluidic device is s thermoplastic injection-molded microfluidic device.

Embodiment 8D. The microfluidic device of any of embodiments 1D-7D, further comprising a thin film applied in the form of the surface of the microfluidic device.

Embodiment 9D. The microfluidic device of embodiment 8D wherein the thin film in the form of the surface provides an outer surface of the plurality of microchambers.

Embodiment 10D. The microfluidic device of embodiment 9D wherein the surface formed by the thin film further provides an outer surface of the plurality of loading conduits.

Embodiment 11D. The microfluidic device of any of embodiments 8D-10D, wherein the thin film has a thickness between about 70 and 90 microns.

Embodiment 12D. The microfluidic device of embodiment any of embodiments 8D-10D wherein the thin film has a thickness of about 80 microns.

Embodiment 13D. The microfluidic device of any of embodiment 8D-12D, wherein the thin film comprises a gas-permeable thermoplastic material.

Embodiment 14D. The microfluidic device of embodiment 13D wherein the gas-permeable thermoplastic material is not permeable to the sample.

Embodiment 15D. The microfluidic device of any of embodiments 13D-14D, wherein the gas-permeable thermoplastic material comprises a cyclic olefin copolymer.

Embodiment 16D. The microfluidic device of any of embodiments 1D-15D wherein at least a portion of said microfluidic device is substantially optically transparent.

Embodiment 17D. The microfluidic device of any of embodiments 1D-15D, wherein the microfluidic device is one of a plurality of microfluidic devices collectively forming a continuous injection-molded thermoplastic part.

Embodiment 18D. The microfluidic device of embodiment 17D, wherein the microfluidic device is not fluidically coupled to another microfluidic device of the plurality of microfluidic devices.

Embodiment 1E. A microfluidic device configured to process a biological sample, comprising: an inlet port; a plurality of microchambers; and a plurality of loading conduits, each fluidically coupled to the inlet port and to the plurality of microchambers, wherein a microchamber of the plurality of microchambers comprises a substantially rectangular three-dimensional shape comprising four substantially rectangular side walls, wherein two adjacent sidewalls are joined by a curved corner.

Embodiment 2E. The microfluidic device of embodiment 1E, wherein the curved corner has a radius of at least about 10 microns.

Embodiment 3E. The microfluidic device of embodiment 1E, wherein each of the plurality of microchambers has a depth of at least about 100 microns.

Embodiment 4E. The microfluidic device of embodiment 1E, wherein a ratio of a depth of the microchamber to a minimum distance between the microchamber and an adjacent microchamber of the plurality of microchambers is at least about 3:1.

Embodiment 5E. The microfluidic device of embodiment 1E, wherein a ratio of a depth of the microchamber to a minimum distance between the microchamber and an adjacent microchamber of the plurality of microchambers is at least about 5:1.

Embodiment 1F. A method of loading a sample into a microfluidic device including a plurality of microfluidic assemblies, each of which is configured to process the sample, the method comprising: applying a plurality of pressure pulses to contents within the microfluidic assemblies, the plurality of pressure pulses comprising a first pressure applied for a first time interval and a second pressure applied for a second time interval, wherein each of the microfluidic assemblies comprises an inlet, a loading conduit fluidically coupled at a first end to the inlet, at least one dead-ended microchamber configured to receive the sample, and a siphon conduit fluidically coupled to the microchamber and the loading conduit, and wherein a volume of the sample is drawn into a plurality of the microchambers of the microfluidic device.

Embodiment 2F. The method of embodiment 1F, wherein the volume of the sample that is drawn into the microfluidic device is less than a total volume capacity of the microchambers.

Embodiment 3F. The method of embodiment 1F, wherein the first pressure is at least about 75 psi and the second pressure is at least about 10 psi.

Embodiment 4F. The method of embodiment 1F, wherein the first time interval and second time interval are substantially equal.

Embodiment 5F. The method of embodiment 1F, wherein the first time interval and the second time interval are each at least about 2.5 seconds and at most about 10 seconds.

Embodiment 6F. The method of embodiment any of embodiments 1F-5F, wherein the microfluidic device further comprises a gas-permeable film that forms a surface of at least one of the loading conduits, the at least one microchamber, and the siphon conduit.

Embodiment 7F. The method of embodiment 6F, wherein the gas-permeable film is not gas permeable at atmospheric pressure, but is gas-permeable at a pressure that is higher than atmospheric pressure.

Embodiment 8F. The method of embodiment 6F wherein applying the pressure pulse forces gas within the at least one microchamber to pass through the gas-permeable film.

Embodiment 9F. The method of embodiment 6F, wherein the gas-permeable film has a thickness of less than about 80 microns.

Embodiment 10F. The method of embodiment 6F, wherein the gas-permeable film comprises a thermoplastic material.

Embodiment 11F. The method of embodiment 10F, wherein the thermoplastic material comprises a cyclic olefin copolymer.

Embodiment 12F. The method of embodiment 6F, wherein the gas-permeable film is substantially transparent.

Embodiment 13F. The method of embodiment 6F, wherein the gas-permeable film is configured to be substantially impermeable to a liquid.

Embodiment 14F. The method of any of embodiments 1F-13F, wherein the method is performed using a single integrated machine.

Embodiment 15F. The method of any of embodiments 1F-14F, wherein the sample comprises a polymerase chain reaction (PCR) reagent and nucleic acid molecules.

Embodiment 16F. A biological sample processing method comprising the loading method of any of embodiments 1F-15F and further comprising performing PCR amplification by thermal cycling the plurality of microchambers.

Embodiment 17F. The method of embodiment 16F, further comprising: acquiring images of the plurality of microchambers.

Embodiment 18F. The method of embodiment 17F, further comprising: counting a number of microchambers within the images of the plurality of microchambers within which PCR amplification has been successfully achieved.

Embodiment 19F. The method of embodiment 18F, further comprising: applying Poisson statistics to the number of the plurality of microchambers within which PCR amplification has been successfully achieved to derive a nucleic acid concentration.

Embodiment 20F. The method of any of embodiments 1F-19F, further comprising: at least one dead-ended terminating chamber fluidically coupled to the loading conduit and configured to receive overfill of the sample to reduce crosstalk.

Embodiment 21F. The method of embodiment any of embodiments 1F-20F, wherein the loading conduit further comprises a plurality of sub-conduits and a splitter conduit structure fluidically coupling the at least one inlet with the plurality of sub-conduits.

Embodiment 22F. The method of embodiment 21F, wherein the plurality of sub-conduits comprises a plurality of linear sub-conduits, and wherein each of the plurality of linear sub-conduits is connected to the splitter conduit structure at a first sub-conduit end and a terminating chamber at a second sub-conduit end.

Embodiment 23F. A method of loading a sample into a microfluidic device configured to process the sample, the microfluidic device comprising an inlet, at least one loading conduit fluidically coupled at a first end to the inlet, a plurality of microchambers, and a plurality of siphon conduits fluidically coupling the plurality of microchambers with the at least one loading conduit, the method comprising: applying a plurality of pressure pulses to fluid contents of the microfluidic device, the plurality of pressure pulses comprising a plurality of peaks comprising a first pressure applied for a first time interval alternating with a plurality of valleys comprising a second pressure applied for a second time interval, thereby forcing gas within the plurality of microchambers to pass through the gas permeable film, wherein a volume of reagent comprising the sample is drawn into the microchambers of the microfluidic device, wherein the microfluidic device further comprises a gas-permeable film that forms a surface of the at least one loading conduit, the plurality of microchambers, and the plurality of siphon conduits.

Embodiment 24F. The method of embodiment 23F, wherein the volume of reagent comprising the sample that is drawn into the microfluidic device is less than a total volume capacity of the plurality of microchambers.

Embodiment 25F. The method of any of embodiments 23F-24F, further comprising drawing a volume of a non-sample fluid into the microfluidic device.

Embodiment 26F. The method of any of embodiments 23F-25F, wherein the first pressure is at least about 75 psi and the second pressure is about 10 psi.

Embodiment 27F. The method of any of embodiments 23F-26F, wherein the first time interval and second time interval are substantially equal.

Embodiment 28F. The method of any of embodiments 23F-26F, wherein the first time interval and the second time interval are each at least about 2.5 seconds and at most about 10 seconds.

Embodiment 29F. The method of any of embodiments 23F-28F, further comprising: applying a third pressure to the fluid contents of the microfluidic device for a third time interval after the plurality of pressure pulses is applied.

Embodiment 30F. The method of embodiment 29F, wherein the third pressure is at least about 50 psi.

Embodiment 31F. The method of any of embodiments 29F-30F, wherein the third time interval is at least about 5 minutes.

Embodiment 32F. The method of any of embodiments 23F-31F, wherein the gas-permeable film has a thickness of less than about 80 microns.

Embodiment 33F. The method of any of embodiments 23F-32F, wherein the gas-permeable film comprises a thermoplastic material.

Embodiment 34F. The method of embodiment 33F, wherein the thermoplastic material comprises a cyclic olefin copolymer.

Embodiment 35F. The method of any of embodiments 23F-34F, wherein the gas-permeable film is substantially transparent.

Embodiment 36F. The method of any of embodiments 23F-35F, wherein the gas-permeable film is configured to be substantially impermeable to a liquid.

1. A microfluidic device configured to process a sample, comprising:
an inlet port; and
a closed system fluidically coupled to the inlet port, wherein the closed system comprises
a plurality of linear loading conduits;
a plurality of terminating chambers, a terminating chamber of the plurality of terminating chambers fluidically coupled to a linear loading conduit of the plurality of linear loading conduits; and
pluralities of microchambers for receiving the sample, a plurality of microchambers of the pluralities of microchambers fluidically coupled to a linear loading conduit of the plurality of linear loading conduits;
wherein, with respect to a first plurality of microchambers and a first terminating chamber fluidically coupled to a same proximate linear loading conduit, a volume of the first terminating chamber is equal to or less than the combined volume of the first plurality of microchambers and further wherein waste reservoirs larger than any one of the terminating chambers are excluded from the closed system.

2. The microfluidic device of claim 1 further comprising a plurality of siphon conduits, a siphon conduit of the plurality of siphon conduits fluidically coupled between a linear loading conduit and a microchamber.

3. The microfluidic device of claim 1, wherein a volume of the terminating chamber is larger than a volume of a microchamber of the plurality of microchambers.

4. The microfluidic device of claim 3, wherein the volume of the terminating chamber is at least about 4 times the volume of the microchamber.

5. The microfluidic device of claim 2, wherein a first dimension of the linear loading conduit and of the siphon conduit is less than about 10 microns.

6. The microfluidic device of claim 1, wherein a microchamber of the plurality of microchambers has a first dimension of at least about 100 microns.

7. The microfluidic device of claim 1, further comprising:
a thin film applied to the microfluidic device wherein the thin film forms a surface of the closed system.

8. The microfluidic device of claim 7 wherein the surface formed by the thin film provides an outer surface of the pluralities of microchambers.

9. The microfluidic device of claim 8 wherein the surface formed by the thin film provides an outer surface of the plurality of linear loading conduits.

10. The microfluidic device of claim 9 wherein the surface formed by the thin film provides an outer surface of the plurality of terminating chambers.

11. The microfluidic device of claim 7, wherein the thin film has a thickness between about 70 and 90 microns.

12. The microfluidic device of claim 7, wherein the thin film has a thickness of about 80 microns.

13. The microfluidic device of claim 7, wherein the thin film comprises a gas-permeable thermoplastic material.

14. The microfluidic device of claim 13, wherein the gas-permeable thermoplastic material is not permeable to the sample.

15. The microfluidic device of claim 13, wherein the gas-permeable thermoplastic material comprises a cyclic olefin copolymer.

16. The microfluidic device of claim 1, wherein the volume of the first terminating chamber is equal to or less than fifty percent (50%) of the combined volume of the first plurality of microchambers.

17. The microfluidic device of claim 1, wherein the volume of the first terminating chamber is equal to or less than twenty-five percent (25%) of the combined volume of the first plurality of microchambers.

18. The microfluidic device of claim 1, wherein the volume of the first terminating chamber is equal to or less than ten percent (10%) of the combined volume of the first plurality of microchambers.

19. The microfluidic device of claim 1, comprising:
an injection-molded thermoplastic material.

20-113. (canceled)
